(19) United States
(12) Patent Application Publication
(10) Pub. No.: US 2020/0363049 A1
(43) Pub. Date: Nov. 19, 2020

(54) CONNECTOR ARRANGEMENT FOR A LUMINAIRE HOUSING

(71) Applicant: BEKA SCHREDER (PROPRIETARY) LTD, Olifantsfontein (ZA)

(72) Inventors: Daniel Kasper, Olifantsfontein (ZA); Irwin Russel, Olifantsfontein (ZA)

(21) Appl. No.: 15/733,473

(22) PCT Filed: Feb. 5, 2019
(86) PCT No.: PCT/IB2019/050902

§ 371 Date: Aug. 4, 2020

(30) Foreign Application Priority Data
Feb. 5, 2018 (BE) 2018/5065
Feb. 5, 2018 (ZA) 2018/00730

(51) Int. Cl. F21V 23/06; F21V 21/088; F21V 23/00; H02G 3/08; F21V 23/02

(52) U.S. Cl. CPC F21V 23/06; F21V 21/088; F21V 23/023; H02G 3/08; F21V 23/008

(57) ABSTRACT

A luminaire housing arrangement comprising a luminaire housing that can accommodate a first electrical connector within the housing, which in turn can be connected to electronic components arid lighting elements within the housing. A connector interface is secured to the luminaire housing, and comprises a first mechanical connector arrangement. The arrangement further includes a supply box for accommodating a second electrical connector which is connected or connectable to a power supply cable, the supply box further comprising a second mechanical connector arrangement to engage the first mechanical connector arrangement, so as to mechanically secure the connector interface, and thus the luminaire housing, and the supply box together, in use.

### FIELD OF THE INVENTION

THIS INVENTION relates to a connector arrangement for a luminaire housing, and in particular to a luminaire housing for underground haulage areas in a mine, for example.

### BACKGROUND OF THE INVENTION

Underground haulage lights typically comprise a housing that can be secured to, or suspended from, a support structure, the housing holding the necessary electronic components and lighting elements. These lights are typically electrically connected to an underground steel wire armoured cable, which comprises insulated copper conductors surrounded by a steel wire armour to provide mechanical strength and protection. A PVC sheath surrounds the armour to hold the components together.

Currently, the steel wire amour is usually severely damaged (or even severed) to enable the housing to be connected to the inner conductors, which is clearly undesirable. In addition, since the electrical components and lighting elements are accommodated within the housing, it is cumbersome and difficult to replace any of these components.

It is therefore the object of the present invention to provide a connector arrangement for a luminaire housing to facilitate maintenance/replacement of the electrical components.

### SUMMARY OF THE INVENTION

According to a first aspect of the present invention there is provided a luminaire housing arrangement comprising:
a luminaire housing that can accommodate a first electrical connector within the housing, which in turn can be connected to electronic components and lighting elements within the housing;
a connector interface secured or securable to the luminaire housing and comprising a first mechanical connector arrangement; and
a supply box for accommodating a second electrical connector which is connected or connectable to a power supply cable, the supply box further comprising a second mechanical connector arrangement to engage the first mechanical connector arrangement, so as to mechanically secure the connector interface, and thus the luminaire housing, and the supply box together, in use, thereby enabling the first and second electrical connectors to be electrically connected together.

In an embodiment, the supply box comprises a supply box base and a supply box cover arranged to define a cavity when fitted together, with the cavity accommodating the second electrical connector, the supply box cover defining a female recess having a recessed flange to define a first key profile.

In an embodiment, a portion of the second electrical connector protrudes through the first key profile to facilitate connection to the first electrical connector of the luminaire housing.

In an embodiment, the supply box cover includes a pair of second connecting elements that together define the second mechanical connector arrangement, each second connecting element comprising a flange body defining a receiving aperture.

In an embodiment, the ends of the supply box include mounting arrangements to securely accommodate the power supply cable, with the interface between the supply box base and supply box cover defining an aperture to enable the power supply cable to extend through the supply box and connected to the second electrical connector within the supply box.

In an embodiment, each mounting arrangement comprises a support body extending away from the supply box to support the power supply cable, with clamps being provided to securely clamp the cable to the support body.

In an embodiment, the connector interface comprises:
a connector base, which can be secured to the luminaire housing;
a recessed flange and surrounding wall to define a cavity, the recessed flange defining a second key profile; and
a connector male portion extending from the recessed flange, which can be accommodated within the female recess of the supply box cover.

In an embodiment, the connector interface includes a pair of first connecting elements that together define the first mechanical connector arrangement.

In an embodiment, each first connecting element comprises a protruding tab with an inwardly extending locking member, the locking members of both first connecting elements being arranged to snap fit within a corresponding receiving aperture of the second connecting elements.

In an embodiment, the first connecting element is designed so that it can only engage with a predetermined one of the second connecting elements, thereby ensuring the correct polarity when the first and second electrical connectors are electrically connected together.

In an embodiment, the luminaire housing comprises a base component comprising a base and a surrounding peripheral (transparent) side wall so as to define a cavity for accommodating the first electrical connector, and a cover.

In an embodiment, the base component of the luminaire housing defines a well to snugly accommodate the connector base of the connector interface.

In an embodiment, the base component of the luminaire housing includes at least one mounting formation to enable the base luminaire to be fitted to a support.

According to a second aspect of the present invention there is provided a connector interface for a luminaire housing arrangement comprising a luminaire housing and a supply box, the connector interface being secured or securable to the luminaire housing and comprising a first mechanical connector arrangement, which can be connected to a second mechanical connector arrangement on the supply box so as to mechanically secure the connector interface, and thus the luminaire housing, and the supply box together.

In an embodiment, the luminaire housing accommodates a first electrical connector within the housing, which in turn can be connected to electronic components and lighting elements within the housing, and the supply box accommodates a second electrical connector which is connected or connectable to a power supply cable, so that when the first and second mechanical connector arrangements engage each other, the first and second electrical connectors are electrically connected together.

In an embodiment, the connector interface comprises:
a connector base, which can be secured to the luminaire housing;
a recessed flange and surrounding wall extending from the connector base; and
a connector male portion extending from the recessed flange, which can be accommodated within a corresponding female recess defined in the supply box.

In an embodiment, the connector interface includes a pair of first connecting elements that together define the first mechanical connector arrangement.

In an embodiment, each first connecting element comprises a protruding tab with an inwardly extending locking member, the locking members of both first connecting elements being arranged to snap fit within a corresponding receiving aperture of the second mechanical connector arrangement on the supply box, the second mechanical connector arrangement comprising a pair of second connecting elements.

In an embodiment, the first connecting element is designed so that it can only engage with a predetermined one of the second connecting elements, thereby ensuring the correct polarity when the first and second electrical connectors are electrically connected together.

According to a third aspect of the present invention there is provided a supply box for a luminaire housing arrangement comprising a luminaire housing that can accommodate a first electrical connector within the housing, which in turn can be connected to electronic components and lighting elements within the housing, and a connector interface secured or securable to the luminaire housing and comprising a first mechanical connector arrangement, the supply box accommodating a second electrical connector which is connected or connectable to a power supply cable, the supply box further comprising a second mechanical connector arrangement to engage the first mechanical connector arrangement, so as to mechanically secure the connector interface, and thus the luminaire housing, and the supply box together, in use, thereby enabling the first and second electrical connectors to be electrically connected together.

In an embodiment, the supply box comprises a supply box base and a supply box cover arranged to define a cavity when fitted together, with the cavity accommodating the second electrical connector, the supply box cover defining a female recess having a recessed flange.

In an embodiment, the supply box cover includes a pair of second connecting elements that together define the second mechanical connector arrangement, each second connecting element comprising a flange body defining a receiving aperture.

In an embodiment, the ends of the supply box include mounting arrangements to securely accommodate the power supply cable, with the interface between the supply box base and supply box cover defining an aperture to enable the power supply cable to extend through the supply box and connected to the second electrical connector within the supply box.

In an embodiment, each mounting arrangement comprises a support body extending away from the supply box to support the power supply cable, with clamps being provided to securely clamp the cable to the support body.

### BRIEF DESCRIPTION OF THE DRAWINGS

FIGS. 1 to 5 show various views of a luminaire housing arrangement according to the invention;

FIGS. 6 to 9 show various views of a supply box for use in the luminaire housing arrangement shown in FIGS. 1 to 5;

FIGS. 10 to 13 show various views of a connector interface for use in the luminaire housing arrangement shown in FIGS. 1 to 5; and

FIGS. 14 to 17 show various views of a sub-assembly of the luminaire housing arrangement shown in FIGS. 1 to 5, the sub-assembly comprising the connector interface, of FIGS. 10 to 13, secured to a luminaire housing.

### DETAILED DESCRIPTION OF AN EXAMPLE EMBODIMENT

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that modifications and adaptations to the present invention are possible and can even be desirable in certain circumstances, and are a part of the present invention. Thus, the following description is provided as illustrative of the principles of the present invention and not a limitation thereof.

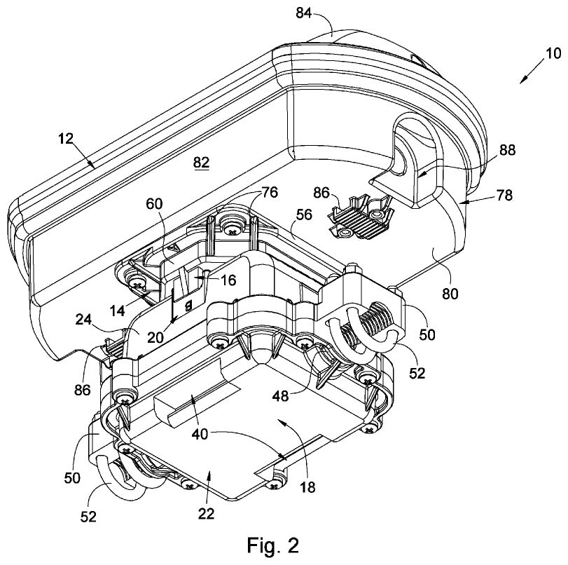

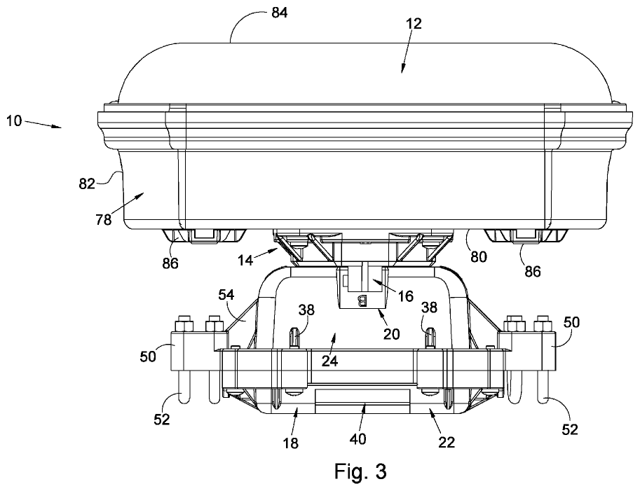

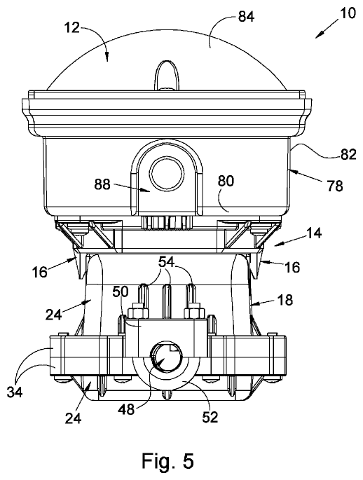

According to a first aspect of the present invention there is provided a luminaire housing arrangement 10. As best shown in FIGS. 2, 3 and 5, the arrangement 10 comprises a luminaire housing 12 that can accommodate a first electrical connector (not shown) within the housing 12. The first electrical connector typically takes the form of a first connector block, which in turn can be connected to electronic components and lighting elements (not shown) within the housing 12.

The arrangement 10 further comprises a connector interface 14 secured or securable to the luminaire housing 12 and comprising a first mechanical connector arrangement 16.

The arrangement 10 may further comprise a supply box or socket 18 for accommodating a second electrical connector (not shown, but typically also in the form of a second connector block) which is connected or connectable to a power supply cable (not shown). The supply box 18 further comprises a second mechanical connector arrangement 20 to engage the first mechanical connector arrangement 16 of the connector interface 14, so as to mechanically secure the connector interface 14, and thus the luminaire housing 12, and the supply box 18 together, in use, thereby enabling the first and second electrical connectors to be electrically connected together.

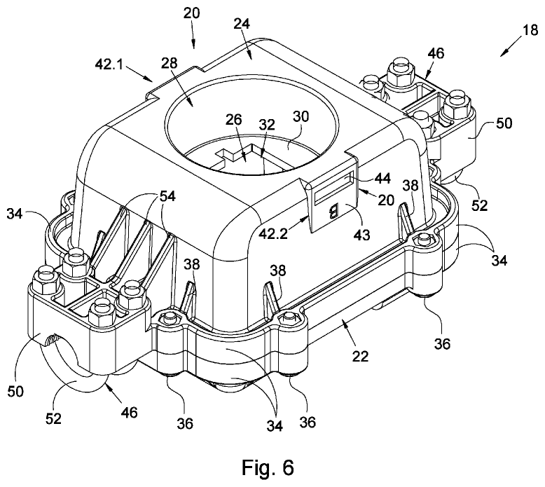

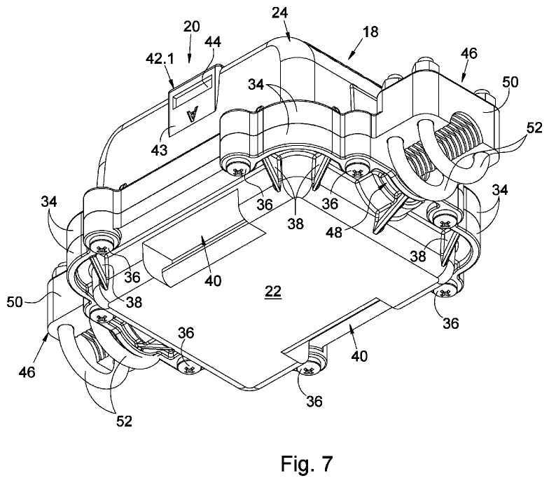

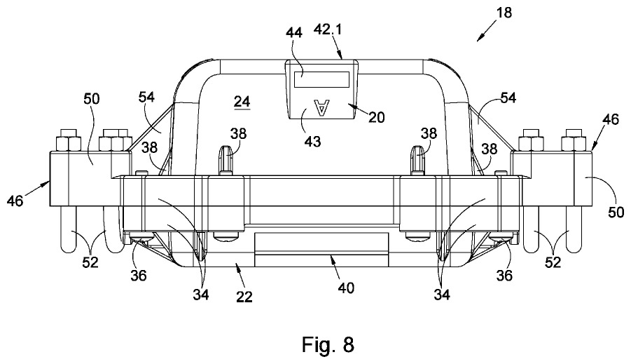

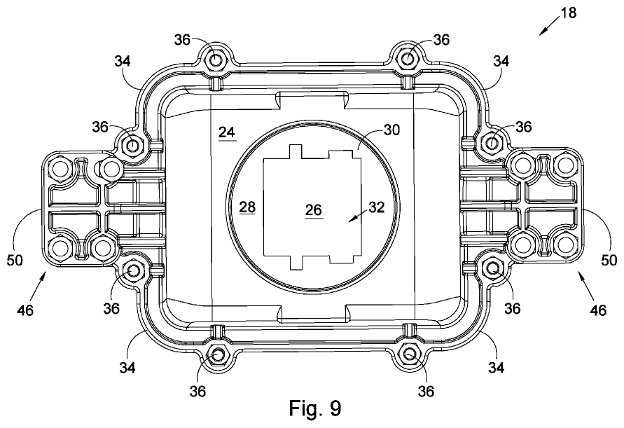

In an embodiment, the supply box 18, as best shown in FIGS. 6 to 9, comprises a supply box base 22 and a supply box cover 24 arranged to define a cavity 26 when fitted together. The cavity 26 accommodates the second electrical connector, the cover 24 defining a circular female recess 28 having a recessed flange 30 to define a first key profile 32.

In an embodiment, a portion of the second electrical connector protrudes through the first key profile 32 to facilitate connection to the first electrical connector of the luminaire housing 12.

The supply box base 22 and supply box cover 24 include complementary reinforced corner connectors 34 that terminate in a pair of aligned apertures to receive screws 36 so as to securely fasten the supply box base 22 and supply box cover 24 together. Support struts 38 may also be provided to support the corner connectors 34. Gripping formations 40 may be provided on the supply box base 22 to facilitate handling of the supply box 18.

In an embodiment, the outside of the cover 24 includes a pair of second connecting elements 42.1 and 42.2 (on opposite ends of the cover 24) that together define the second mechanical connector arrangement 20, each second connecting element 42.1, 42.2 comprising a flange body 43 defining an elongate receiving aperture or slot 44.

In an embodiment, the ends of the supply box 18 include mounting arrangements 46 to securely accommodate the power supply cable. The interface between the supply box base 22 and supply box cover 24 defines an aperture 48 to enable the power supply cable to extend through the supply box 18. In use, a portion of the power supply cable, and in particular the electrical conductors, are separated from the rest of the cable (but with the armour remaining intact) and connected to the second electrical connector within the supply box 18.

In an embodiment, each mounting arrangement 46 comprises a support body 50 extending away from the supply box 18 to support the power supply cable, with clamps 52 being provided to securely clamp the cable to the support body 50 (and thus to the supply box 18). Support struts 54 may also be provided to reinforce the support bodies 50.

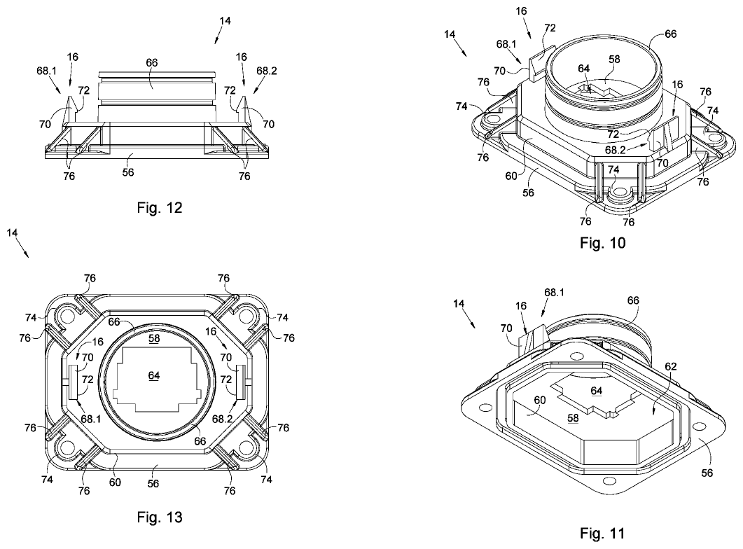

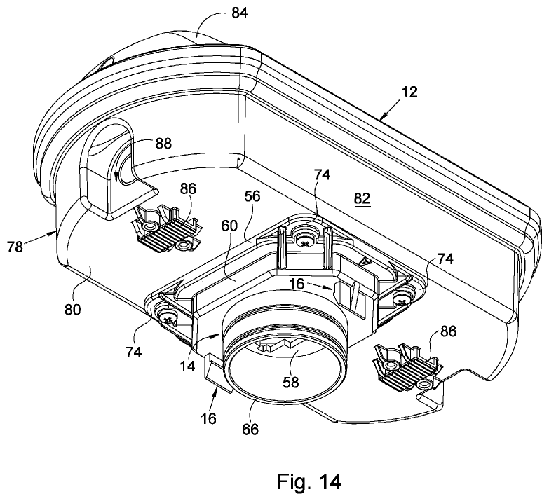

Turning now to FIGS. 10 to 13, the connector interface 14 comprises a connector base 56, which can be secured to the luminaire housing 12. The connector interface 14 further comprises a recessed flange 58 and surrounding wall 60 to define a cavity 62, the recessed flange 58 defining a second key profile 64.

The connector interface 14 further comprises a circular connector male portion 66 extending from the recessed flange 58, which can be accommodated within the female recess 28 of the cover 24 of the supply box 18.

In an embodiment, the connector interface 14 includes a pair of first connecting elements 68.1, 68.2 on opposite ends of the connector interface 14, extending away from the surrounding wall 60, and spaced apart from the connector male portion 66, which together define the first mechanical connector arrangement 16.

In an embodiment, each first connecting element 68.1, 68.2 comprises a protruding tab 70 with an inwardly extending, elongate locking member 72. The locking members 72 of both first connecting elements 68.1, 68.2 are arranged to snap fit within a corresponding receiving aperture or slot 44 of the second connecting elements 42.1 and 42.2.

In an embodiment, the first connecting elements 68.1, 68.2 are designed so that they can only engage with a predetermined one of the second connecting elements 42.1, 42.2, thereby ensuring the correct polarity when the first and second electrical connectors are electrically connected together.

The connector interface 14 includes reinforced corner connectors 74 having apertures that may be aligned with corresponding apertures defined in the luminaire housing 12, to facilitate the mounting of the connector interface 14 to the luminaire housing 12. Support struts 76 may also be provided to support the corner connectors 74, and typically extend between the corner connectors 74 and the surrounding wall 60 of the recessed flange 58.

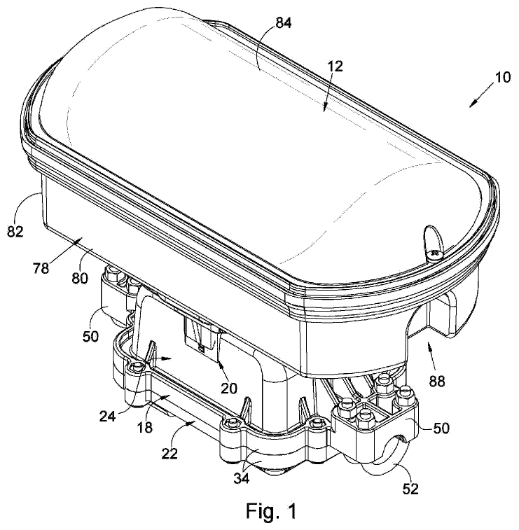

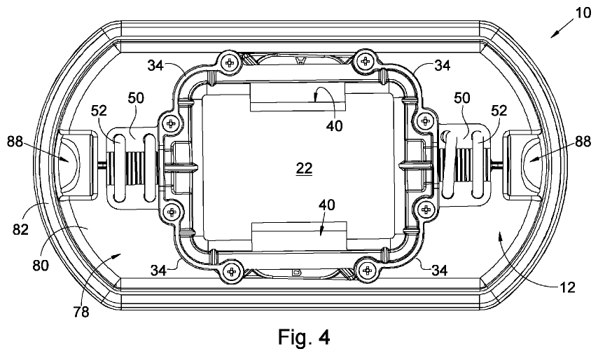

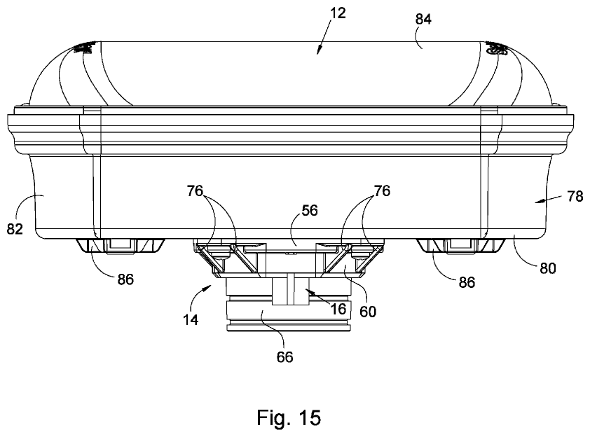

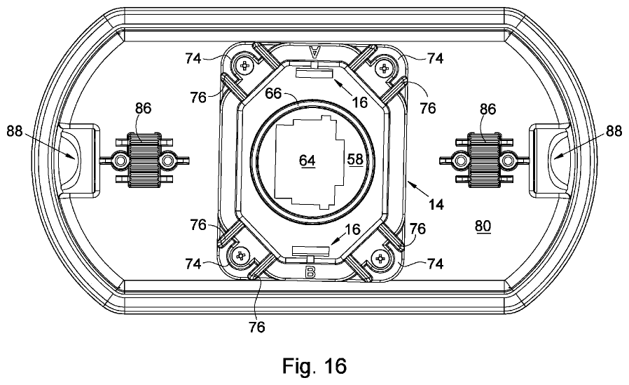

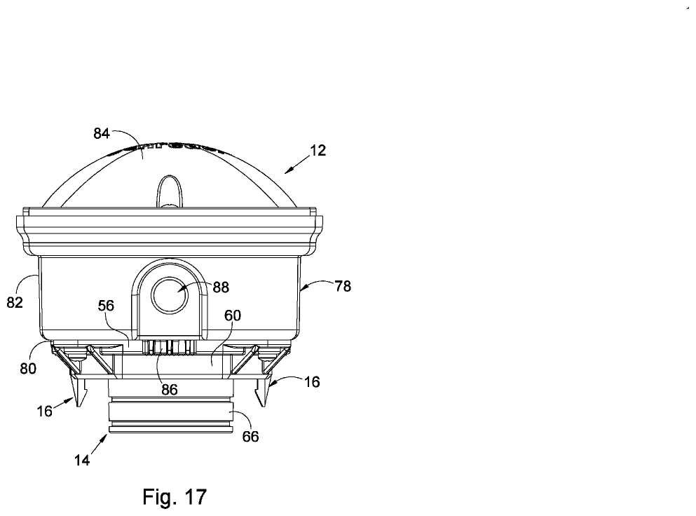

Now turning back to FIGS. 1 to 5, and also turning to FIGS. 15 to 17, the luminaire housing 12 comprises a base component 78 comprising a transparent base 80 and a surrounding peripheral transparent side wall 82 so as to define a cavity for accommodating the first electrical connector, and a transparent cover 84.

In an embodiment, the base component 78 of the luminaire housing 12 defines a well to snugly accommodate the connector base 56 of the connector interface 14.

In an embodiment, the base component 78 of the luminaire housing 12 includes a pair of spaced apart mounting formations 86 to enable the luminaire housing 12 to be fitted (strapped, for example) to a support.

In an embodiment, the ends of the transparent side wall 82 define recessed apertures 88 to enable a power supply cable to enter directly into the luminaire housing 12.

1. A luminaire housing arrangement comprising:
a luminaire housing that can accommodate a first electrical connector within the housing, which in turn can be connected to electronic components and lighting elements within the housing;
a connector interface secured or securable to the luminaire housing and comprising a first mechanical connector arrangement; and
a supply box for accommodating a second electrical connector which is connected or connectable to a power supply cable, the supply box further comprising a second mechanical connector arrangement to engage the first mechanical connector arrangement, so as to mechanically secure the connector interface, and thus the luminaire housing, and the supply box together, in use, thereby enabling the first and second electrical connectors to be electrically connected together.

2. The luminaire housing arrangement of claim 1, wherein the supply box comprises a supply box base and a supply box cover arranged to define a cavity when fitted together, with the cavity accommodating the second electrical connector, the supply box cover defining a female recess having a recessed flange to define a first key profile.

3. The luminaire housing arrangement of claim 2, wherein a portion of the second electrical connector protrudes through the first key profile to facilitate connection to the first electrical connector of the luminaire housing.

4. The luminaire housing arrangement of claim 3, wherein the supply box cover includes a pair of second connecting elements that together define the second mechanical connector arrangement, each second connecting element comprising a flange body defining a receiving aperture.

5. The luminaire housing arrangement of claim 4, wherein the ends of the supply box include mounting arrangements to securely accommodate the power supply cable, with the interface between the supply box base and supply box cover defining an aperture to enable the power supply cable to extend through the supply box and connected to the second electrical connector within the supply box.

6. The luminaire housing arrangement of claim 5, wherein each mounting arrangement comprises a support body extending away from the supply box to support the power supply cable, with clamps being provided to securely clamp the cable to the support body.

7. The luminaire housing arrangement of claim 6, wherein the connector interface comprises:
a connector base, which can be secured to the luminaire housing;
a recessed flange and surrounding wall to define a cavity, the recessed flange defining a second key profile; and
a connector male portion extending from the recessed flange, which can be accommodated within the female recess of the supply box cover.

8. The luminaire housing arrangement of claim 7, wherein the connector interface includes a pair of first connecting elements that together define the first mechanical connector arrangement.

9. The luminaire housing arrangement of claim 8, wherein each first connecting element comprises a protruding tab with an inwardly extending locking member, the locking members of both first connecting elements being arranged to snap fit within a corresponding receiving aperture of the second connecting elements.

10. The luminaire housing arrangement of claim 9, wherein the first connecting element is designed so that it can only engage with a predetermined one of the second connecting elements, thereby ensuring the correct polarity when the first and second electrical connectors are electrically connected together.

11. The luminaire housing arrangement of any one of claims 7 to 10, wherein the luminaire housing comprises a base component comprising a base and a surrounding peripheral side wall so as to define a cavity for accommodating the first electrical connector, and a cover.

12. The luminaire housing arrangement of claim 11, wherein the base component of the luminaire housing defines a well to snugly accommodate the connector base of the connector interface.

13. The luminaire housing arrangement of claim 11, wherein the base component of the luminaire housing includes at least one mounting formation to enable the base luminaire to be fitted to a support.

14. A connector interface for a luminaire housing arrangement comprising a luminaire housing and a supply box, the connector interface being secured or securable to the luminaire housing and comprising a first mechanical connector arrangement, which can be connected to a second mechanical connector arrangement on the supply box so as to mechanically secure the connector interface, and thus the luminaire housing, and the supply box together.

15. The connector interface of claim 14, wherein the luminaire housing accommodates a first electrical connector within the housing, which in turn can be connected to electronic components and lighting elements within the housing, and the supply box accommodates a second electrical connector which is connected or connectable to a power supply cable, so that when the first and second mechanical connector arrangements engage each other, the first and second electrical connectors are electrically connected together.

16. The connector interface of claim 15, wherein the connector interface comprises:
a connector base, which can be secured to the luminaire housing;
a recessed flange and surrounding wall extending from the connector base; and
a connector male portion extending from the recessed flange, which can be accommodated within a corresponding female recess defined in the supply box.

17. The connector interface of claim 16, wherein the connector interface includes a pair of first connecting elements that together define the first mechanical connector arrangement.

18. The connector interface of claim 17, wherein each first connecting element comprises a protruding tab with an inwardly extending locking member, the locking members of both first connecting elements being arranged to snap fit within a corresponding receiving aperture of the second mechanical connector arrangement on the supply box, the second mechanical connector arrangement comprising a pair of second connecting elements.

19. The connector interface of claim 18, wherein the first connecting element is designed so that it can only engage with a predetermined one of the second connecting elements, thereby ensuring the correct polarity when the first and second electrical connectors are electrically connected together.

20. A supply box for a luminaire housing arrangement comprising a luminaire housing that can accommodate a first electrical connector within the housing, which in turn can be connected to electronic components and lighting elements within the housing, and a connector interface secured or securable to the luminaire housing and comprising a first mechanical connector arrangement, the supply box accommodating a second electrical connector which is connected or connectable to a power supply cable, the supply box further comprising a second mechanical connector arrangement to engage the first mechanical connector arrangement, so as to mechanically secure the connector interface, and thus the luminaire housing, and the supply box together, in use, thereby enabling the first and second electrical connectors to be electrically connected together.

21. The supply box of claim 20, wherein the supply box comprises a supply box base and a supply box cover arranged to define a cavity when fitted together, with the cavity accommodating the second electrical connector, the supply box cover defining a female recess having a recessed flange.

22. The supply box of claim 21, wherein the supply box cover includes a pair of second connecting elements that together define the second mechanical connector arrangement, each second connecting element comprising a flange body defining a receiving aperture.

23. The supply box of claim 22, wherein the ends of the supply box include mounting arrangements to securely accommodate the power supply cable, with the interface between the supply box base and supply box cover defining an aperture to enable the power supply cable to extend through the supply box and connected to the second electrical connector within the supply box.

24. The supply box of claim 23, wherein each mounting arrangement comprises a support body extending away from the supply box to support the power supply cable, with clamps being provided to securely clamp the cable to the support body.
